(19) United States
(12) Patent Application Publication
(10) Pub. No.: US 2008/0047586 A1
(43) Pub. Date: Feb. 28, 2008

(54) SYSTEMS AND METHODS FOR OPERATING AND MONITORING ABATEMENT SYSTEMS

(76) Inventors: Youssef A. Loldj, Sunnyvale, CA (US); Shaun W. Crawford, San Ramon, CA (US)

Correspondence Address: DUGAN & DUGAN, PC, 245 Saw Mill River Road, Suite 309, Hawthorne, NY, 10532, US

(21) Appl. No.: 11/844,268

(22) Filed: Aug. 23, 2007

Related U.S. Application Data
(60) Provisional application No. 60/823,292, filed on Aug. 23, 2006.

(51) Int. Cl. B08B 7/04; B08B 3/10

(52) U.S. Cl. 134/18; 134/56 R

(57) ABSTRACT

Methods and systems are provided for abating effluent from a process tool. The invention includes one or more process tools; one or more abatement systems; and an interface manifold adapted to establish effluent fluid communication between the one or more process tools and the one or more abatement systems, wherein the interface manifold is configured to selectively direct one or more effluents from between the one or more process tools to the one or more abatement systems in response to a control signal. Numerous other aspects are provided.

The present application claims priority from U.S. Provisional Patent Application Ser. No. 60/823,292 filed Aug. 23, 2006, entitled “ABATEMENT SYSTEM WITH BACK-UP FUNCTIONALITY AND METHOD OF USING THE SAME” (Attorney Docket No. 11469/L).

### CROSS-REFERENCE TO RELATED APPLICATIONS

The present application is related to the following commonly-assigned, co-pending U.S. patent applications, which are hereby incorporated herein by reference in their entirety for all purposes:

U.S. Provisional Patent Application Ser. No. 60/823,294, filed Aug. 23, 2006, entitled “SYSTEM FOR MONITORING MULTIPLE ABATEMENT SYSTEMS AND METHOD OF USING THE SAME” (Attorney Docket No. 11470/L); and

U.S. patent application Ser. No. 12/______, filed Aug. 23, 2007, entitled “AN INTERFACE FOR OPERATING AND MONITORING ABATEMENT SYSTEMS.” (11470)

### FIELD OF THE INVENTION

The present invention relates to semiconductor device manufacturing, and more specifically to methods and systems for abatement systems having back-up functionality.

### BACKGROUND

The gaseous effluents from the manufacturing of semiconductor materials, devices, products and memory articles involve a wide variety of chemical compounds used and produced in the process facility. These compounds include inorganic and organic compounds, breakdown products of photo-resist and other reagents, and a wide variety of other gases that must be removed from the waste gas before being vented from the process facility into the atmosphere.

Semiconductor manufacturing processes utilize a variety of chemicals, many of which have extremely low human tolerance levels. During processing (e.g. physical vapor deposition, diffusion, etch PFC processes, epitaxy, etc.), some of the tools used (e.g., chemical vapor deposition chamber, chemical mechanical polishing chamber, diffusion, etc.) as well as the processes may produce undesirable byproducts including, for example, perfluorocompounds (PFCs) or byproducts that may decompose to form PFCs. PFCs are recognized to be strong contributors to global warming.

These undesirable byproducts may be removed from the effluent streams via an abatement system. The abatement system may convert gases produced by the processing of substrates and flat panel display/LCD to less environmentally harmful versions to be emitted to the environment. The abatement systems may be coupled to semiconductor manufacturing tools, and typically may abate the process gases from the tool as they are produced. While the abatement systems have a flow capacity capable of handling process gases from a tool, they may go down for various reasons including, for example, scheduled and unscheduled maintenance, etc. Accordingly a need exists for a system that allows the continued abatement of process gases from a tool when an abatement system coupled with the tool is down.

### SUMMARY OF THE INVENTION

In aspects of the invention, a system is provided for abating effluent from a process tool. The system comprises one or more process tools; one or more abatement systems; and an interface manifold adapted to establish effluent fluid communication between the one or more process tools and the one or more abatement systems, wherein the interface manifold is configured to selectively direct one or more effluents from between the one or more process tools to the one or more abatement systems in response to a control signal.

In other aspects of the invention, an apparatus is provided for abating effluent from a process tool. The apparatus comprises one or more first channels; one or more second channels; and a plurality of valves operatively coupled to the first and second channels, wherein the one or more first channels allow fluid communication from one or more process tools to one or more first abatement systems and the one or more second channels allow fluid communication from one or more process tools to one or more second abatement systems, and wherein at least one valve of the plurality of valves is operable to select between the one or more first and second channels to flow at least one effluent stream.

In yet other aspects of the invention, a method is provided for abating effluent from a process tool. The method includes the steps of (1) flowing effluent output by one or more process tools through an interface manifold to one or more abatement systems; (2) receiving an indicia representative of a status of a first abatement system of the one or more abatement systems, wherein the status indicates the first abatement system is unavailable to process effluent; and (3) directing effluent via the interface manifold to a second abatement system of the one or more abatement systems in response to receiving the indicia.

Other features and aspects of the present invention will become more fully apparent from the following detailed description, the appended claims and the accompanying drawings.

### BRIEF DESCRIPTION OF THE FIGURES

FIG. 1 is a schematic diagram of a system for operating and monitoring one or more abatement systems in accordance with an embodiment of the present invention.

FIG. 2 is a schematic diagram of a system for operating and monitoring one or more abatement systems in accordance with an embodiment of the present invention.

FIG. 3 is a schematic diagram of an exemplary system for operating and monitoring one or more abatement systems in accordance with an embodiment of the present invention.

FIG. 4 is a schematic diagram of an exemplary system having a back-up configuration for operating and monitoring one or more abatement systems in accordance with an embodiment of the present invention.

FIG. 5 is a schematic diagram of an exemplary system having an application specific configuration for operating and monitoring one or more abatement systems in accordance with an embodiment of the present invention.

FIG. 6 is a schematic diagram of an exemplary system having a load balancing configuration for operating and monitoring one or more abatement systems in accordance with an embodiment of the present invention.

FIG. 7 is a schematic diagram of an exemplary system having a redundant configuration for operating and monitoring one or more abatement systems in accordance with an embodiment of the present invention.

FIG. 8 is a flowchart illustrating an exemplary method for operating and monitoring one or more abatement systems in accordance with an embodiment of the present invention.

### DETAILED DESCRIPTION

The present invention provides systems and methods for controlling the flow of effluent streams from electronic device manufacturing tools to abatement systems. The invention enables automated re-direction of the effluent streams in the case of scheduled or unscheduled events that impact the system's ability to abate the effluent streams. For example, in a system with two abatement systems (e.g., a primary system and a back-up system), the present invention is adapted to automatically redirect an effluent stream from the primary to the back-up abatement system in response to, for example, an alarm indicating that the primary abatement system is going offline.

In some embodiments, the present invention provides an interface manifold that may include a series of valves (e.g., electronically controlled valves) adapted to open, close, and/or switch channels between one or more electronic device processing tools and one or more abatement systems. The interface manifold may be coupled to and operated by a controller that receives information from the processing tools and abatement systems. For example, in response to information indicating a primary system has malfunctioned, the controller may open valves in channels between the processing tools and a back-up abatement system while concurrently closing valves in channels between the processing tools and the primary system.

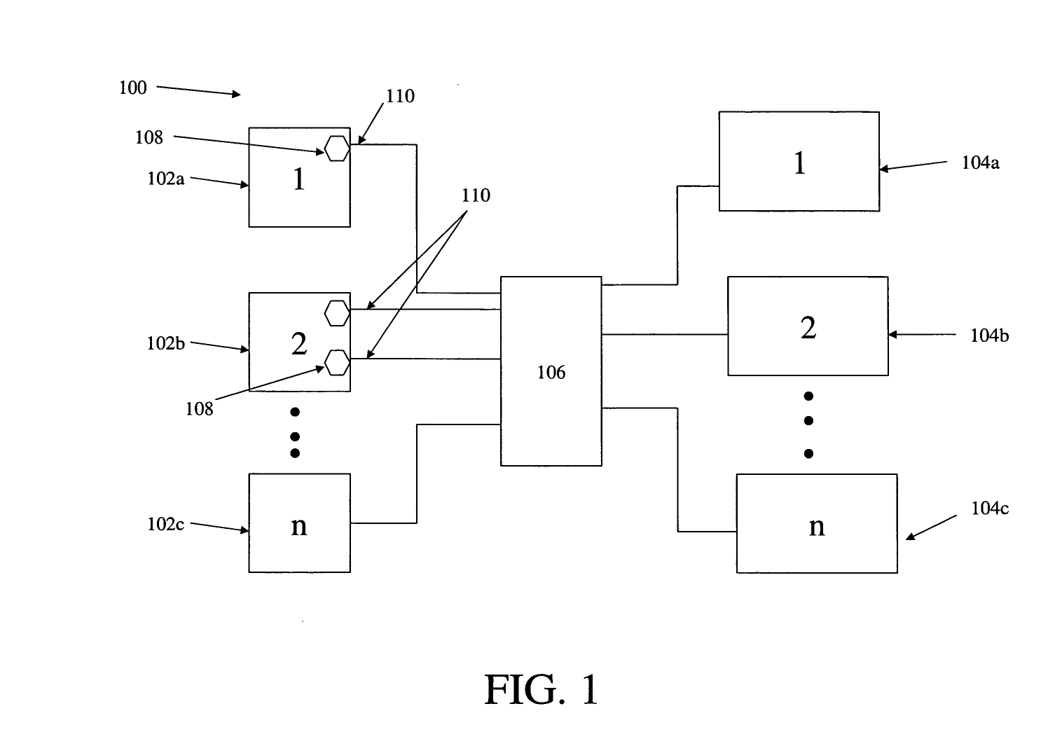

Turning to FIG. 1 of the present invention, a system 100 is provided. The system may include at least one process tool 102 coupled to at least two abatement system 104 via an interface manifold 106, which allows fluid communication between the process tool 102 and the abatement system 104. Alternatively, the system may include at least two process tools 102 coupled to at least one abatement system 104 via the interface manifold 106. In the embodiment shown herein, N process tools 102a, 102b, 102c and N abatement systems 104a, 104b, 104c are shown. Any number of process tools 102 and abatement systems 104 may be included (e.g., 1, 2, . . . , n)

### Process Tools

Each process tool 102 may include one or more process chambers 108. The process tools 102a-c may include, for example, chemical vapor deposition chambers, physical vapor deposition chambers, chemical mechanical polishing chambers, etc. The processes that may be performed in the chambers include, for example, diffusion, etch PFC processes and epitaxy. The byproduct chemicals to be abated from these processes may include, for example, hydrides of antimony, arsenic, boron, germanium, nitrogen, phosphorous, silicon, selenium, silane, silane mixtures with phosphine, argon, hydrogen, organosilanes, halosilanes, halogens, organometallics and other organic compounds. The halogens, e.g., fluorine (F₂) and other fluorinated compounds, are particularly problematic among the various components requiring abatement. The electronics industry frequently uses perfluorinated compounds (PFCs) in substrate processing tools to remove residue from deposition steps and to etch thin films. Examples of some of the most commonly used PFCs include CF₄, C₂F₆, SF₆, C₃F₈, C₄H₈, C₄H₈O, NF₃, CHF₃, CH₃F, CH₂F₂.

### Interface Manifold

A channel 110 may extend from each chamber 108 to allow the flow of one or more effluents to exit the process tool 102a. In the exemplary embodiment described herein, process tool 102a may include a single chamber and a single corresponding channel, while process tool 102b may include two chambers and corresponding channels.

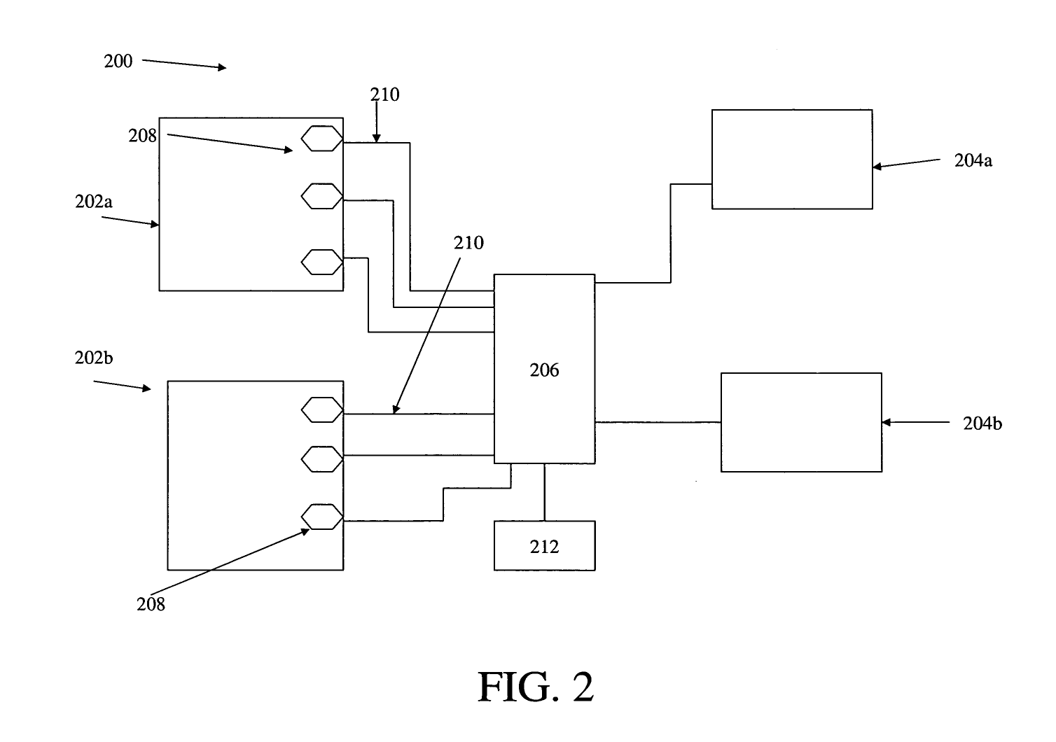

The effluent may flow from the process tools 102 through the channels 110 and into the interface manifold 106. The interface manifold 106 may include one or more valves (not shown) that act as gates on the channels 110 to permit or prevent the flow of effluent into the interface manifold 106. The interface manifold 106 may also include one or more valves (FIG. 2) to selectively direct the effluents from the different channels 110 into the abatement systems 104.

A controller 112 may selectively manipulate the operation of the valves in the interface manifold 106. Alternatively, or additionally, the controller 112 may selectively manipulate the operation of a plurality of pumps (not shown), which aid in moving the effluent through the system 100. The controller 112 may be hardwired or wirelessly coupled to the interface manifold 106. In some embodiments, the controller 112 may be an integral part of and contained in the interface manifold 106 while in other embodiments, the controller 112 may be apart and separate from the interface manifold 106. In some embodiments, the controller 112 may be coupled to and/or otherwise communicate with and/or control operation of one or more of the process tools 102a-c and abatement systems 104a-c as described further below. The controller 112 may be a microcomputer, microprocessor, logic circuit, a combination of hardware and software, or the like. The controller 112 may include various communications facilities including input/output ports, a keyboard, a mouse, a display, a network adapter, etc.

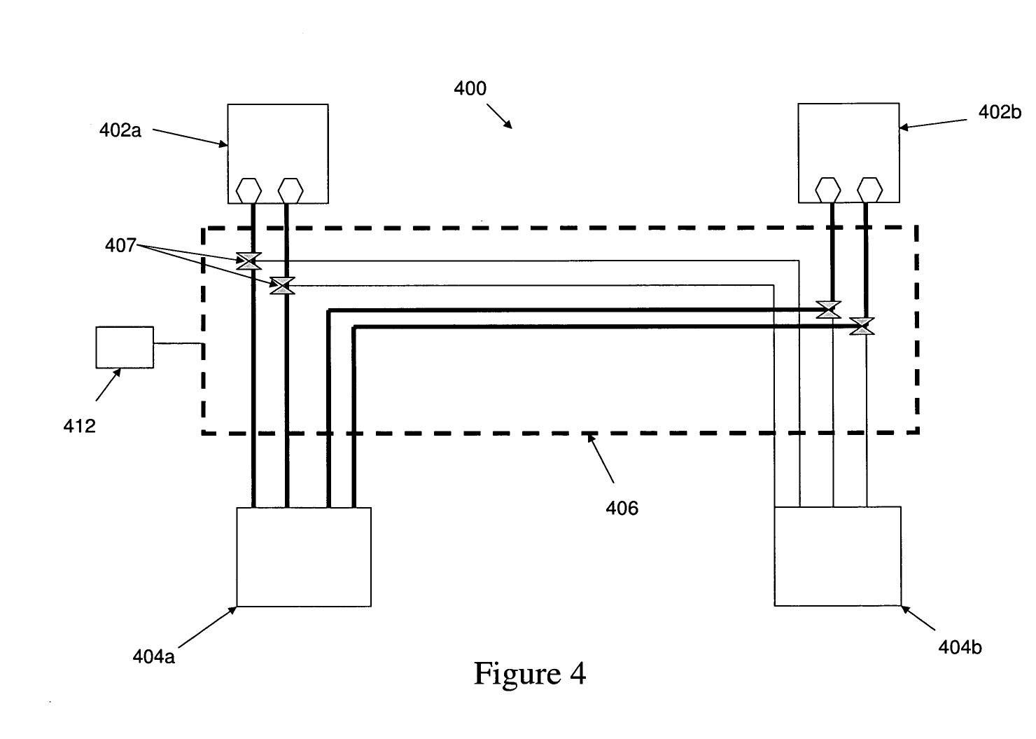

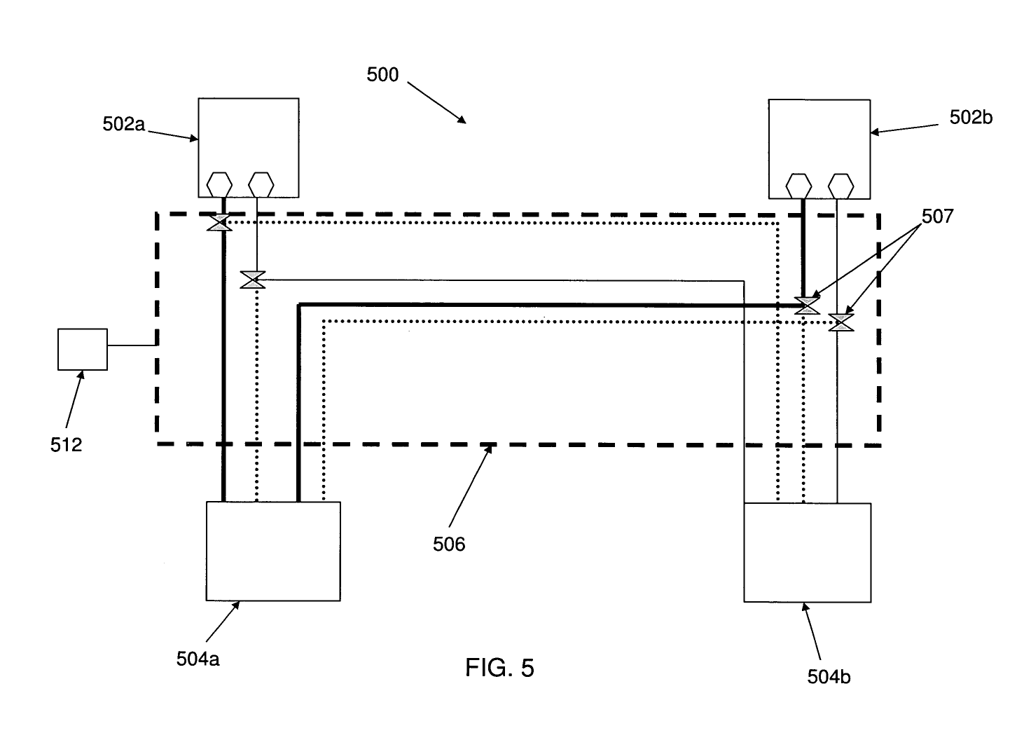

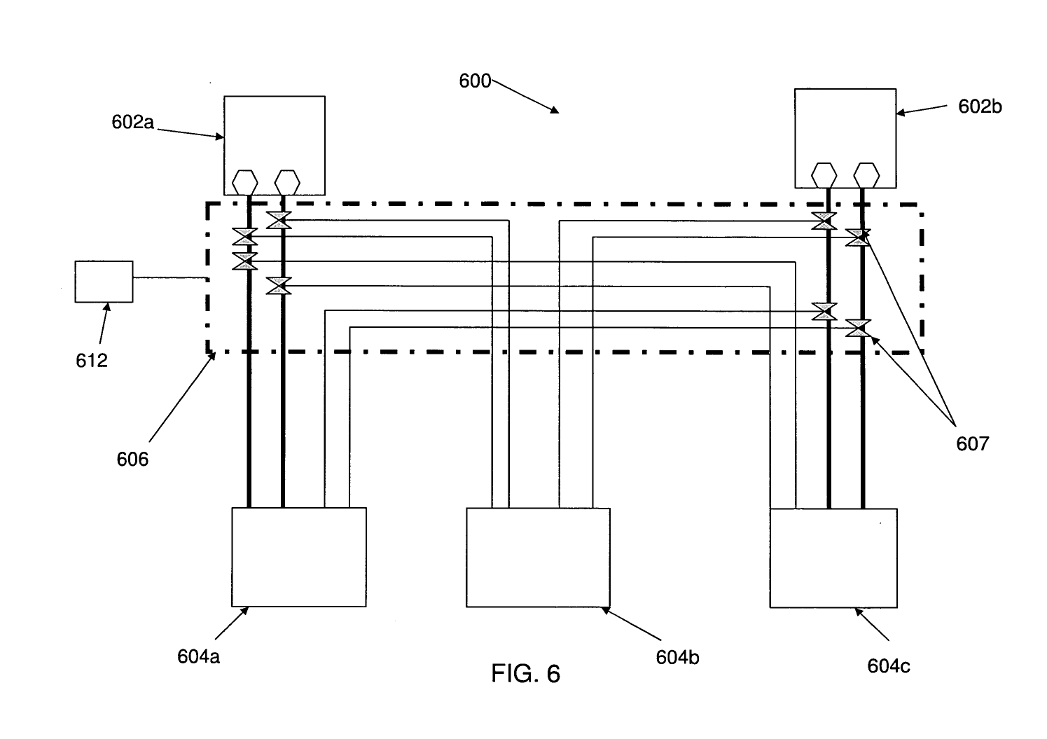

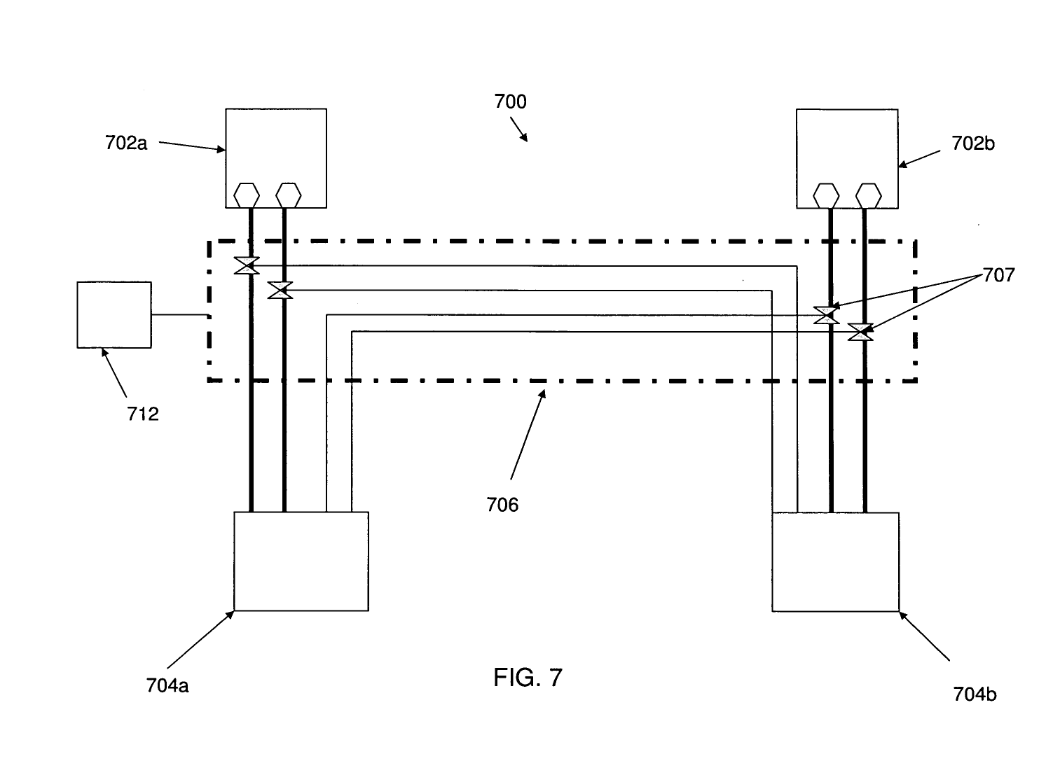

The controller 112 may receive signals from sensors (described below) attached to, for example, the process tools 102a-c, abatement systems 104a-c, channels 110, the interface manifold 106, inlets (described below), and the like, and based on these signals may selectively determine which of the abatement systems 104a-c to direct a particular effluent flow. The controller 112 may also cause the valves in the interface manifold 106 to carry out the selection. The determination may be based on a plurality of factors. These factors may be for example, scheduled and unscheduled events that may cause a particular abatement system to be unable to abate effluent. Possible configurations for the scheduled and unscheduled events may include for example, to create a back-up configuration (FIG. 4), as an abatement application specific distribution system for different types of tools/processes (FIG. 5), as an automated load balancing system among similar or different types/capacities of abatement units (FIG. 6), as a redundant configuration (FIG. 7) etc.

### Abatement Systems

Typically, processing operations associated with electronic device manufacturing produce effluent that may include, for example, mostly fluorine, silicon tetrafluoride (SiF₄), hydrogen fluoride (HF), carbonyl fluoride (COF₂), CF₄ and C₂F₆. Abatement systems may use, for example, thermal, wet scrubbing, dry scrubbing, catalytic, plasma and/or similar means for the treatment of the effluent gases, as well as processes for converting the effluent gases to less toxic forms. Exemplary abatement systems 104a-c may include, e.g., the CDO Abatement System, having an input flow rate capacity of 300 liters per minute, and the Marathon Abatement System, having an input flow rate capacity of 1100 liters per minute, both manufactured by Applied Materials of Santa Clara, Calif. The input flow rate capacity of each abatement system may be such that it may accommodate effluent from multiple tools.

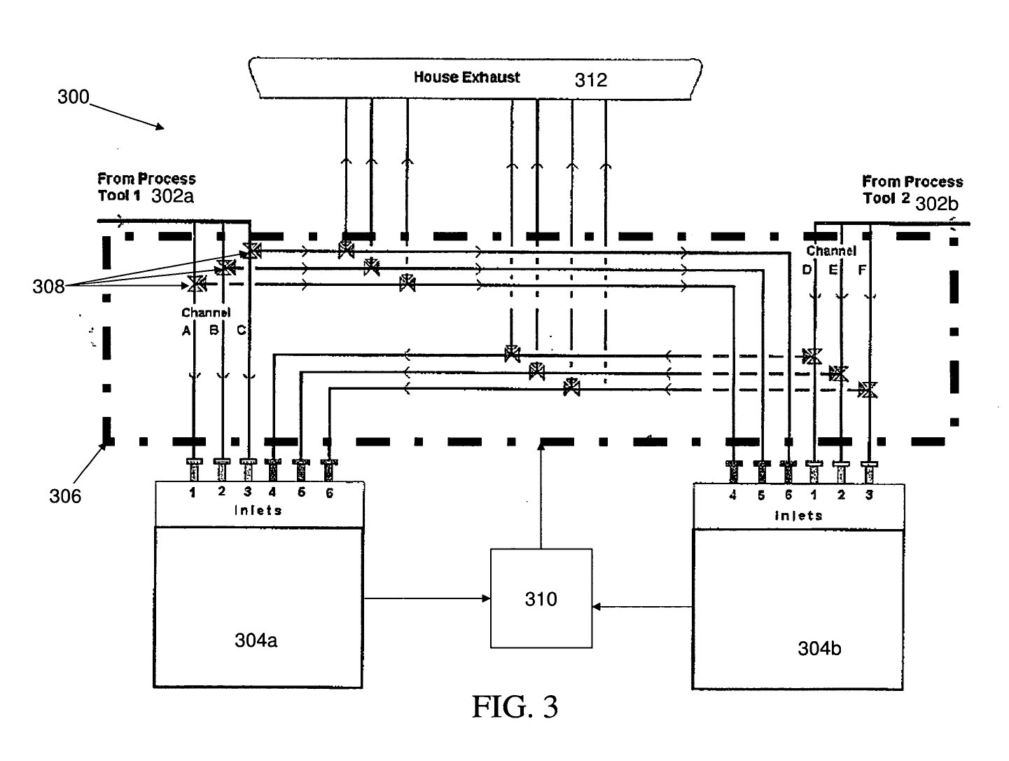

The abatement systems 104a-c may include one or more inlets, as shown in FIG. 3, for receiving the effluent from the interface manifold 106. The abatement systems 104a-c may include 1, 2, 3 . . . n inlets. In some exemplary embodiments, the inlets may be divided between those dedicated to effluent flows from specific tools and those used as back-up for another abatement system. For example, an unscheduled event may result in half of the inlets from the first abatement system 104a receiving effluent flows from the first tool 102a and the other half of the inlets from the first abatement system 104a receiving effluent flows from a second tool 102b. For example, a first abatement system 104a may receive effluent flows from a first process tool 102a through inlets 1, 2, and 3 of the first abatement system 104a, and a second abatement system 104b may receive effluent flows from a second process tool 102b through inlets 1, 2, and 3 of the second abatement system 104b. If the second abatement system 104b becomes unavailable, the effluent flows from the second process tool 102b may be directed, via the interface manifold 206, to inlets 4, 5, and 6 of the first abatement system 104a. Alternatively, the purpose of the inlets may change depending on the circumstance.

The inlets, and hence the abatement systems 104a-c, may be monitored by one or more sensors (not shown). For example, some sensors may be used to monitor the effluent flow rate, the pressure at the inlets, the temperature of the systems, the effluent composition, etc. The sensors may send one or more signals to the controller 112 indicative of the status of the abatement system 104a-c, such that an appropriate action may be taken. In some embodiments, the one or more sensors may be coupled to the process tools 102a-c, or coupled to both the abatement systems 104a-c and the process tools 102a-c to provide information to the controller 112.

Turning to FIG. 2, an example system 200 is provided. The similar reference numerals used to describe the system 100 above with respect to FIG. 1 and the system 200 below with respect to FIG. 2, describe similar features.

As described herein, the system 200 includes two process tools 202a and 202b coupled to two abatement systems 204a and 204b via an interface manifold 206, which allows fluid communication between the process tools 202a-b and the abatement systems 204a-b.

In the embodiment shown herein, each process tool 202a-b includes three process chambers 208 (A, B, C and D, E, F, respectively). A corresponding channel 210 (A, B, C and D, E, F) may extend from each chamber 208 to allow the flow of one or more effluents to exit the process tool 202a-b. Each of the two abatement systems 204a-b includes six inlets (1, 2, 3, 4, 5, 6). The three (A, B, C) channels 208 of the first process tool 202a may be in fluid communication, via the interface manifold 206, with inlets 1, 2, 3 of the first abatement system 204a. If the first abatement system 204a is unavailable, the effluent from the first process tool 202a may flow through channels A, B, C to inlets 4, 5, 6 of the second abatement system 204b. The three (D, E, F) channels 208 of the second process tool 202b may be in fluid communication, via the interface manifold 206, with inlets 1, 2, 3 of the second abatement system 204b. If the second abatement system 204b is unavailable, the effluent from the second process tool 202b may flow through channels D, E, F to inlets 4, 5, 6 of the first abatement system 204a.

Turning to FIG. 3, a schematic illustration of an exemplary embodiment of a system 300 is provided. The system 300 is similar to the system 200 shown in FIG. 2, in that it includes two process tools 302a-b coupled to two abatement systems 304a-b via an interface manifold 306 (dashed line). However, the system 300 shown herein includes additional details of an exemplary interface manifold 306. As described above, the interface manifold 306 may include one or more valves 307 to selectively direct the effluents from the different channels 308 of the process tools into the abatement systems 304a-b. Exemplary valves suitable for use may include gate valves, needle valves, bellow valves, or ball valves, or other types of valves. In a preferred embodiment, ball valves may be used. Examples of ball valves may include the Series SMC9 valves manufactured by SVF Flow Controls of Santa Fe Springs, Calif., the CFDM3L/3T5900 Series valves manufactured by J-Flow of Norwood, Ohio, the Triad Series 30L-92061 & 30T-92061 valves manufactured by Triad Process Equipment of Milford, Mich., and the multiport series manufactured by Flow-Tek of Houston, Tex.

In an exemplary operative embodiment, the three (A, B, C) channels 308 of the first process tool 302a may be in fluid communication, via the interface manifold 306, with inlets 1, 2, 3 of the first abatement system 304a. As described above, the first abatement system 304a may include one or more sensors (not shown). The sensor may send a signal to the controller 310 indicating that the first abatement system 304a is unavailable to abate effluent. In an alternate embodiment, the process tools may include sensors, which send signals to the controller indicating a status of the abatement system. The controller 310, in turn, operates the valves 307 in the interface manifold 306 to direct the effluent flow to inlets 4, 5, 6 of the second abatement system 304b instead of inlets 1, 2, 3 of the unavailable first abatement system 304a. In various embodiments, the valves 307 may be manipulated automatically or manually. Similarly, the three (D, E, F) channels 308 of the second process tool 302b may be in fluid communication, via the interface manifold 306, with inlets 1, 2, 3 of the second abatement system 304b. As described above, sensors may detect the unavailability of the second abatement system 304b and may send a signal indicative of this status to the controller 310. The controller 310, in response, may operate the valves 307 to direct the effluent flow to inlets 4, 5, 6 of the first abatement system 304a instead of inlets 1, 2, 3 of the unavailable second abatement system 304b.

The system 300 may also include a house exhaust scrubber 312, which may serve as an additional level of back-up abatement. Thus, in a situation where both abatement systems 304a-b unexpectedly become unavailable, the valves may be actuated to direct the effluent, via the interface manifold and controller, into the house exhaust scrubber 312 for abatement.

Turning to FIG. 4, an exemplary embodiment of a system 400 adapted to function in a back-up configuration is depicted. The example system 400 includes two process tools 402a and 402b coupled to two abatement systems 404a and 404b via an interface manifold 406 (dashed line), which selectively enables fluid communication between the process tools 402a-b and the abatement systems 404a-b.

In the case of a back-up configuration, the effluent from both process tools 402a-b is directed to only the primary abatement system 404a, as indicated by the bold line, while the secondary abatement system 404b remains dormant. If the primary abatement system 404a is shut down for a scheduled (e.g., planned maintenance) or unscheduled situation, (e.g., an emergency shutdown due to a component failure), the controller 412 may receive a signal indicating the shutdown status, and operates the valves 407 of the interface manifold 406 to redirect the effluent flow from both process tools 402a-b to only the secondary abatement system 404b, as indicated by the unbolded lines. The use of a secondary abatement system 404b as a back-up to the primary abatement system 404a improves environmental compliance by allowing the continual flow of effluent into an abatement system and thereby does not necessitate bypassing a down abatement system and flowing the effluent directly to the house exhaust.

Turning to FIG. 5, an exemplary embodiment of a system 500 adapted to function in a abatement application specific distribution configuration for different types of tools/processes is depicted. The system 500 includes two process tools 502a and 502b coupled to two abatement systems 504a and 504b via an interface manifold 506 (dashed line), which selectively enables fluid communication between the process tools 502a-b and the abatement systems 504a-b.

An exemplary case of an application specific system may be one in which the effluents from substrate processing in the process tools 502a-b are directed, via the interface manifold 506, to a first abatement system 504a, as indicated by the bold lines, while effluents from cleaning the process tools 502a-b are directed to a second abatement system 504b, as indicated by the unbold lines. The dotted channel lines and valves 507 provide the ability to redirect the effluent flows. It may be desirable to direct the different effluents to different abatement systems 504a-b, as the effluents may have, for example, different corrosive and combustive properties. In the case of the process effluent and the cleaning effluent, the cleaning effluent may be more corrosive and combustive than the process effluent, and therefore wear the abatement system 504b faster than the process effluent. In addition to customizing/adapting different systems by adding different equipment or using different fuels/methods of abating in different abatement systems, prediction of needed maintenance (e.g., replacement of consumable parts) may be more accurately done by limiting the use of individual systems to fewer processes. In keeping with the process effluent and cleaning effluent example, for example, the timing of the replacement of the system processing the more corrosive cleaning effluent may be more accurately predicted from known rates of corrosion.

Turning to FIG. 6, an exemplary embodiment of a system 600 adapted to function in a automated load balancing configuration among similar or different types/capacities of abatement units is depicted. The example system 600 includes two process tools 602a and 602b coupled to three abatement systems 604a, 604b and 604c via an interface manifold 606 (dashed line), which allows fluid communication between the process tools 602a-b and the abatement systems 604a-c.

In the example described herein, the first and third abatement systems 604a and 604c are Marathon abatement systems, each having a flow rate capacity of 1100 liters per minute, and the second abatement system 604b is a CDO abatement system having a flow rate capacity of 300 liters per minute. Because the second abatement system 604b has a flow rate capacity so much lower than the first and third abatement systems 604a and 604c, it may be desirable to only run the first and third abatement systems 604a and 604c, in particular situations. An example of such a particular situation may be when between more than 1300 liters per minute and less than 2000 liters per minute of effluent is abated. When between more than 1000 liters per minute and less than 1300 liters per minute of effluent is going to be abated, only the first and second abatement systems 604a-b may be used. When between more than 300 liters per minute and less than 1000 liters per minute of effluent is to be abated, only the second abatement system 604b may be used. When between more than 0 liters per minute and less than 300 liters per minute of effluent is to be abated, only the first abatement system 604a may be used. When between more than 2000 liters per minute and less than 2300 liters per minute of effluent is to be abated, all three of the abatement systems 604a-c may be used.

Other parameters and thresholds may be used to determine which abatement systems 604a-c are used. In some embodiments algorithms that optimize the use of the various abatement systems based on, for example, efficiency and/or cost, may be used to select which systems or system combinations are used when. Thus, in the example shown herein, the controller 612 operates the valves 607 of the interface manifold 606 to direct the effluent flow from the process tools 604a-b to the first and third 604a and 604c abatement systems, as indicated by the bold lines.

Turning to FIG. 7, an exemplary embodiment of a system 700 adapted to function in a redundant configuration is depicted. The system 700 includes two process tools 702a and 702b coupled to two abatement systems 704a and 704b via an interface manifold 706 (dashed line), which selectively enables fluid communication between the process tools 702a-b and the abatement systems 704a-b

An exemplary case of a redundant system may be one in which the effluents from a first process tool 702a are directed to a first abatement system 704a and the effluents from a second process tool 702b are directed to a second abatement system 704b, as indicated by the bold lines. If either of the abatement systems 704a,b become unable to abate effluents, a signal may be sent to the controller 712 indicating the down status of the abatement system, for example the first abatement system 704a. The controller 712, in response, may operate the valves 707 to direct the effluent flow from the first process tool 702a to the second abatement system 704b, as indicated by the unbold lines.

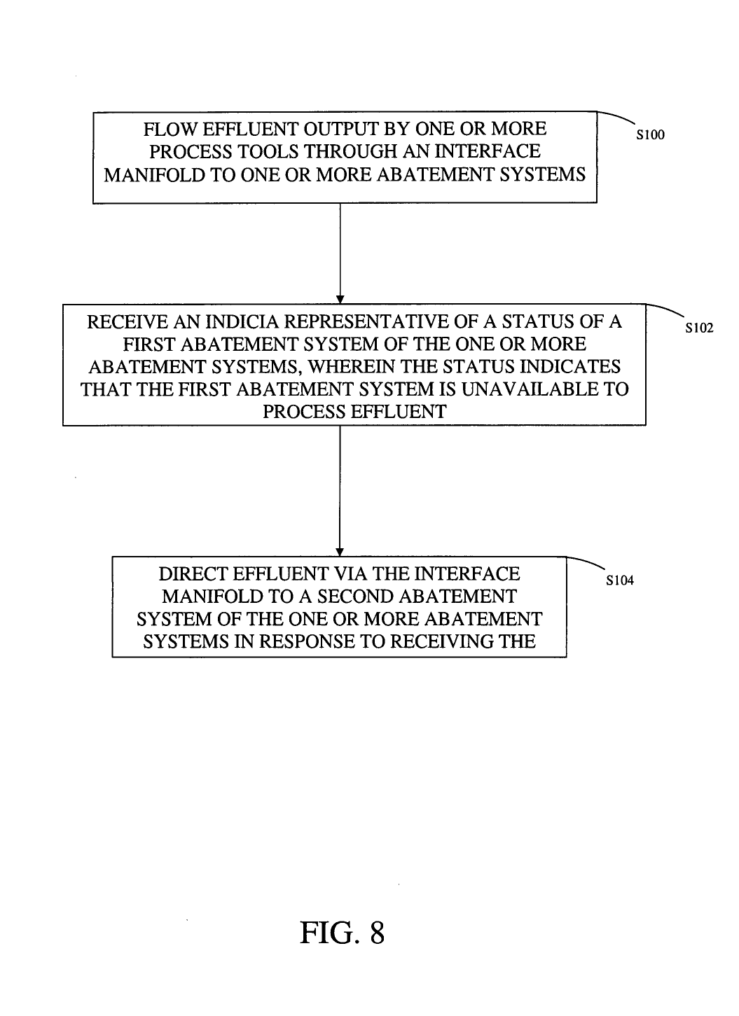

Turning to FIG. 8, a flowchart illustrating an exemplary method of the effluent flow configuration shown in FIG. 2 for abating effluent from a process tool is depicted. However, the method may be applied to any of the exemplary configurations described herein. In step S100, an effluent output by one or more process tools 202a-b (FIG. 2) is flowed through an interface manifold 206 (FIG. 2) to one or more abatement systems 204a-b (FIG. 2). In step S102, an indicia is received representing a status of a first abatement system 204a of the one or more abatement systems. The status may indicate that the first abatement system 204a is unavailable to process effluent. Then in step S104, the effluent is directed, via the interface manifold 206, to a second abatement system 204b in response to receiving the indicia. Further, alternate methods for various configurations are described in U.S. Patent Application Ser. No. 60/823,294, filed Aug. 23, 2006, entitled “SYSTEM FOR MONITORING MULTIPLE ABATEMENT SYSTEMS AND METHOD OF USING THE SAME” (Attorney Docket No. 10470).

The foregoing description discloses only exemplary embodiments of the invention. Modifications of the above disclosed apparatus and methods which fall within the scope of the invention will be readily apparent to those of ordinary skill in the art. In some embodiments, the apparatus and methods of the present invention may be applied to semiconductor device processing and/or electronic device manufacturing.

Accordingly, while the present invention has been disclosed in connection with exemplary embodiments thereof, it should be understood that other embodiments may fall within the spirit and scope of the invention, as defined by the following claims.

The invention claimed is:

1. A system for abating effluent from a process tool comprising:
one or more process tools;
one or more abatement systems; and
an interface manifold adapted to establish effluent fluid communication between the one or more process tools and the one or more abatement systems, wherein the interface manifold is configured to selectively direct one or more effluents from between the one or more process tools to the one or more abatement systems in response to a control signal.

2. The system of claim 1, wherein the one or more process tools further comprises one or more chambers adapted to output at least one effluent.

3. The system of claim 2, wherein the one or more chambers further comprises one or more channels adapted to direct the at least one effluent output by the chamber to the one or more abatement systems via the interface manifold.

4. The system of claim 3, further comprising a controller adapted to cause the interface manifold to selectively direct the one or more effluents to the one or more abatement systems.

5. The system of claim 4, wherein the controller is adapted to at least one of automatically and manually cause the interface manifold to direct the one or more effluents or manually direct the one or more effluents.

6. The system of claim 4, wherein the controller is adapted to cause the interface manifold to selectively direct the one or more effluents to the one or more abatement systems in response to an indicia representative of a status of the one or more abatement systems.

7. The system of claim 6, wherein the status of the one or more abatement systems is at least one of available to process effluent and unavailable to process effluent.

8. The system of claim 1, wherein the one or more abatement systems are adapted to create a redundancy.

9. The system of claim 1, wherein the one or more abatement systems are adapted to create a back-up configuration.

10. The system of claim 1, wherein the one or more abatement systems are adapted to be configured as an automated load balancing system among at least one of similar and different types and capacities of abatement units.

11. The system of claim 1, wherein the one or more abatement systems are adapted to be configured as an abatement application specific distribution system for different types of at least one of tools and processes.

12. An apparatus for abating effluent from a process tool comprising:
one or more first channels;
one or more second channels; and
a plurality of valves operatively coupled to the first and second channels, wherein the one or more first channels allow fluid communication from one or more process tools to one or more first abatement systems and the one or more second channels allow fluid communication from one or more process tools to one or more second abatement systems, and wherein at least one valve of the plurality of valves is operable to select between the one or more first and second channels to flow at least one effluent stream.

13. The apparatus of claim 12, further comprising a controller adapted to determine the selection between the one or more first and second channels.

14. The apparatus of claim 13, wherein the controller is adapted to select between the one or more first and second channels in response to an indicia representative of a status of the one or more abatement systems.

15. The apparatus of claim 13, wherein the controller is adapted to select between the one or more first and second channels in response to an indicia representative of a status of the one or more process tools.

16. The apparatus of claim 12, wherein at least one of the one or more first and second abatement systems is a backup system.

17. The apparatus of claim 12, wherein the one or more first and second abatement systems perform redundant functions.

18. The apparatus of claim 12, wherein the one or more first and second abatement systems are different types of abatement systems.

19. The apparatus of claim 18, wherein the one or more first and second abatement systems have different capacities.

20. The apparatus of claim 13, wherein the controller is adapted to direct the at least one effluent via the interface manifold between the first and second abatement systems based on the effluent type.

21. The apparatus of claim 20, wherein the one or more first abatement systems is adapted to abate processing effluent and the one or more second abatement systems is adapted to abate cleaning effluent.

22. A method for abating effluent from a process tool comprising:
flowing effluent output by one or more process tools through an interface manifold to one or more abatement systems;
receiving an indicia representative of a status of a first abatement system of the one or more abatement systems, wherein the status indicates the first abatement system is unavailable to process effluent; and
directing effluent via the interface manifold to a second abatement system of the one or more abatement systems in response to receiving the indicia.

23. The method of claim 22, wherein the effluent is flowed to the first abatement system.

24. The method of claim 23, wherein the indicia is received from a sensor in at least one of the one or more process tools and the first abatement system of the one or more abatement systems.

25. The method of claim 23, wherein directing the effluent further comprises the step of operating at least one valve in the interface manifold.

26. The method of claim 23, wherein operating the at least one valve is at least one of automatic and manual.

27. The method of claim 23, wherein the unavailability of the first abatement system is at least one of scheduled and unscheduled.

28. The method of claim 23, further comprising the step of abating the effluent in the second abatement system of the one or more abatement systems.
